(19) United States
(12) Patent Application Publication
(10) Pub. No.: US 2018/0018887 A1
(43) Pub. Date: Jan. 18, 2018

(54) ROUTING AIRCRAFT GROUND MOVEMENTS AT AN AIRPORT

(71) Applicant: Honeywell International Inc., Morris Plains, NJ (US)

(72) Inventors: Manuj Sharma, Bangalore (IN); Karel Macek, Prague (CZ); Kameswararao Belamkonda, Nellore (IN); Sumanth E, Visakhapatnam (IN)

(21) Appl. No.: 15/212,491

(22) Filed: Jul. 18, 2016

(51) Int. Cl. G08G 5/06

(52) U.S. Cl. CPC G08G 5/065

(57) ABSTRACT

Devices, methods, and systems for routing aircraft ground movements at an airport are described herein. One device includes a memory, a processor configured to execute executable instructions stored in the memory to receive information associated with current aircraft ground movements at an airport and determine a possible adjustment to a current aircraft ground movement route at the airport based, at least in part, on the information associated with the current aircraft ground movements, and a user interface configured to provide the possible adjustment to the current aircraft ground movement route to a user of the device.

### TECHNICAL FIELD

The present disclosure relates to devices, methods, and systems for routing aircraft ground movements at an airport.

### BACKGROUND

An important part of ground operations at an airport is routing aircraft from one part of the airport to another, such as, for instance, routing the aircraft from the gate to the runway and vice versa. These ground movement routes may be determined and/or provided by, for example, an advanced surface movement guidance and control system (ASMGCS).

In previous approaches, however, the routes determined and/or provided by the ASMGCS may be static routes that do consider or take into account the dynamic nature of aircraft ground movements (e.g., traffic) at the airport. As such, during operation it is left up to the air traffic controller to manually evaluate the current aircraft ground movements at the airport, and manually adjust the routes if he or she believes the routes could be made shorter (e.g., quicker) and/or safer.

This manual evaluation and adjustment, however, can have a negative impact on the efficiency of the air traffic controller by, for example, increasing the “head down time” for the controller. This can interfere with and/or decrease the safety of the ground operations at the airport.

### BRIEF DESCRIPTION OF THE DRAWINGS

FIG. 1 illustrates a computing device for routing aircraft ground movements at an airport in accordance with one or more embodiments of the present disclosure.

FIG. 2 illustrates an example structure of a hidden Markov model in accordance with one or more embodiments of the present disclosure.

FIG. 3 illustrates a method for routing aircraft ground movements at an airport in accordance with one or more embodiments of the present disclosure.

### DETAILED DESCRIPTION

Devices, methods, and systems for routing aircraft ground movements at an airport are described herein. For example, one or more embodiments include a memory, a processor configured to execute executable instructions stored in the memory to receive information associated with current aircraft ground movements at an airport and determine a possible adjustment to a current aircraft ground movement route at the airport based, at least in part, on the information associated with the current aircraft ground movements, and a user interface configured to provide the possible adjustment to the current aircraft ground movement route to a user of the device.

Embodiments of the present disclosure can determine and/or provide aircraft ground movement routes that consider and/or take into account the dynamic nature of aircraft ground movements (e.g., traffic) at the airport. For instance, an advanced surface movement guidance and control system (ASMGCS) in accordance with the present disclosure can evaluate the current aircraft ground movements at the airport, and determine and/or provide an adjusted route based on (e.g., in response to) the current movements. In contrast, previous ASMGCS approaches may only be able to determine and/or provide static routes that do consider or take into account current aircraft ground movements during operation.

As such, embodiments of the present disclosure can increase the efficiency of air traffic controllers, which can increase the safety of airport ground operations. For example, an air traffic controller may experience less “head down time” while using an ASMGCS in accordance with the present disclosure than while using a previous ASMGCS.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a” or “a number of” something can refer to one or more such things. For example, “a number of routes” can refer to one or more routes.

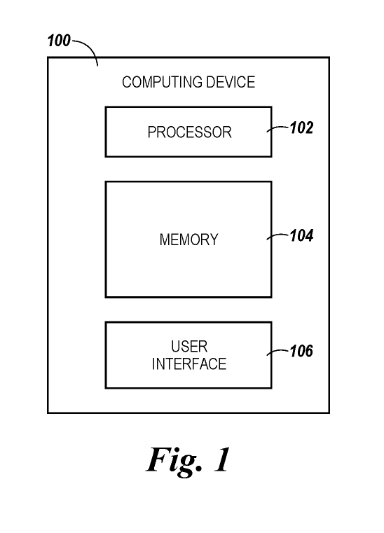

FIG. 1 illustrates a computing device 100 for routing aircraft ground movements at an airport in accordance with one or more embodiments of the present disclosure. Computing device 100 can be, for example, a laptop computer, desktop computer, or mobile device (e.g., smart phone, tablet, PDA, etc.), among other types of computing devices. However, embodiments of the present disclosure are not limited to a particular type of computing device. In some embodiments, computing device 100 can be a computing device of an advanced surface movement guidance and control system (ASMGCS) of the airport.

As shown in FIG. 1, computing device 100 can include a memory 104 and a processor 102. Memory 104 can be any type of storage medium that can be accessed by processor 102 to perform various examples of the present disclosure. For example, memory 104 can be a non-transitory computer readable medium having computer readable instructions (e.g., computer program instructions) stored thereon that are executable by processor 102 to route aircraft ground movements at an airport in accordance with the present disclosure. That is, processor 102 can execute the executable instructions stored in memory 104 to route aircraft ground movements at an airport in accordance with the present disclosure.

Memory 104 can be volatile or nonvolatile memory. Memory 104 can also be removable (e.g., portable) memory, or non-removable (e.g., internal) memory. For example, memory 104 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 104 is illustrated as being located in computing device 100, embodiments of the present disclosure are not so limited. For example, memory 104 can also be located internal to another computing resource (e.g., enabling computer readable instructions to be downloaded over the Internet or another wired or wireless connection).

As shown in FIG. 1, computing device 100 can include a user interface 106. A user (e.g., operator) of computing device 100, such as, for instance, an air traffic controller of the airport, can interact with computing device 100 via user interface 106. For example, user interface 106 can provide (e.g., display and/or present) information to the user of computing device 100, such as, for instance, a possible adjustment to a current aircraft ground movement route, as will be further described herein. Further, user interface 106 can receive information from (e.g., input by) the user of computing device 100, such as, for instance, an acceptance of a possible adjustment to a current aircraft ground movement route, as will be further described herein.

In some embodiments, user interface 106 can be a graphical user interface (GUI) that can include a display (e.g., a screen) that can provide and/or receive information to and/or from the user of computing device 100. The display can be, for instance, a touch-screen (e.g., the GUI can include touch-screen capabilities). As an additional example, user interface 106 can include a keyboard and/or mouse the user can use to input information into computing device 100. Embodiments of the present disclosure, however, are not limited to a particular type(s) of user interface.

As an example, in some embodiments, computing device 100 can receive information associated with current (e.g., present) aircraft ground movements (e.g., traffic) at the airport. The information can include, for example, observations and/or measurements of the current aircraft ground movements, such as changes (e.g., an increase or decrease) in congestion in the current aircraft ground movements, the current number of landings taking place on the runway(s) of the airport, the current occupancy status of the exit and/or entrance branch(s) of the runway(s) (e.g., whether the branch is free or occupied), and/or differences in the traffic at different parts of the runway(s), among other types of information and/or observations. Computing device 100 can receive the information from, for example, an air traffic controller of the airport (e.g., via user interface 106), and/or from other components of the ASMGCS.

Computing device 100 can propose an adjustment to a current (e.g., present) aircraft ground movement route at the airport based, at least in part, on the information associated with the current aircraft ground movements. For example, computing device 100 can determine a possible adjustment to the current aircraft ground movement route based, at least in part, on the information associated with the current aircraft ground movements, and provide the possible adjustment to the current aircraft ground movement route to the user of the computing device (e.g., the air traffic controller) via user interface 106. For instance, user interface 106 can display a map of the airport runway that includes (e.g., highlights) the proposed route adjustment.

The current aircraft ground movement route can be, for example, a current route of an aircraft from a gate of the airport to a runway and/or runway holding point of the airport, or a current route of an aircraft from a runway of the airport to a gate and/or gate bay of the airport.

Computing device 100 can determine the possible adjustment to the current aircraft ground movement route using a set of aircraft ground movement routing rules. For example, computing device 100 can determine the possible adjustment to the route by applying the set of routing rules to the information associated with the current aircraft ground movements received by computing device 100. For instance, the information associated with the current aircraft ground movements may be input into and trigger one or more of the rules. The rule(s) that get triggered may depend on the information that is input (e.g., different rules may be triggered under different aircraft ground movement conditions and/or situations).

The set of aircraft ground movement routing rules can enumerate (e.g., capture and/or reflect) actions that an air traffic controller would take under different aircraft ground movement conditions and/or situations. For instance, the set of rules can enumerate the exceptions from normal ground operation conditions under which the air traffic controller would operate.

For example, the set of rules can correspond to different (e.g., favored) aircraft ground movement routes and/or route adjustments that an air traffic controller would select and/or make under different aircraft ground movement conditions and/or situations. As an example, the air traffic controller may direct an aircraft from a particular gate or bay to a different taxiway if its originally assigned taxiway is experiencing high traffic. As an additional example, the air traffic controller may adjust a route to go across a particular runway if the number of landings occurring on that runway are decreasing. As an additional example, the air traffic controller may direct an aircraft to a particular runway exit or entrance branch if that branch has no traffic. As an additional example, an the air traffic controller may reroute the pushback direction of an aircraft pushing back from a gate in a bay if its current pushback direction would be blocked by other aircraft pushbacks in the bay.

The set of aircraft ground movement routing rules can be determined (e.g., built and/or learned) based on interactions (e.g., interviews) with the air traffic controller and/or based on previous (e.g., recorded and/or historical) data. For example, the set of rules can be determined based, at least in part, on information associated with previous aircraft ground movements at the airport and previous aircraft ground movement routes at the airport (e.g., which routes were previously used under different aircraft ground movement conditions and/or situations). Further, the set of rules can be determined based, at least in part, on information received from the user (e.g., the air traffic controller) of computing device 100 via user interface 106. In some embodiments, the set of rules can be stored in memory 104 of computing device 100.

In some embodiments, the set of aircraft ground movement routing rules can correspond to (e.g., be embedded as) a set of states of a hidden Markov model, and computing device 100 can use the hidden Markov model to determine the possible adjustment to the current aircraft ground movement route using the hidden Markov model. For example, the information associated with the current aircraft ground movements can be input into the hidden Markov model, and computing device 100 can then use the hidden Markov model to determine the possible adjustment to the route.

Each respective state of the set of states of the hidden Markov model can correspond to a different aircraft ground movement route at the airport, and the possible adjustment to the current aircraft ground movement route can include an adjustment of the current aircraft ground movement route to one of the different routes in the set of states of the hidden Markov model. For instance, computing device 100 can determine (e.g., calculate), using the hidden Markov model, levels of belief in each respective state of the set of states (e.g., in each of the different routes in the set), and the possible adjustment to the current aircraft ground movement route can include an adjustment (e.g., switch) to one of the different aircraft ground movement routes in the set of states if the level of belief in the state of the set corresponding to that respective route meets or exceeds a particular threshold. The threshold can correspond to a particular (e.g., high enough) probability that the route will work (e.g., will be quicker than the current route and/or will be safe).

For instance, the information associated with the current aircraft ground movements that is input into the hidden Markov model may trigger the model to change the levels of belief in each respective state in the set of states of the model (e.g., in each of the different routes of the set). Once the level of belief in one of the state in the set of states (e.g., in one of the routes in the set) reaches the particular threshold, an adjustment of the current aircraft ground movement route to the route of that state may be proposed.

As an example, the set of states may include routes that cross a particular runway and routes that avoid crossing that particular runway. Upon receiving information about (e.g., observations of) the number of landings currently taking place on that runway, the hidden Markov model may calculate a level of belief (e.g., probability) that the number of landings taking place on that runway are decreasing and the routes that cross that runway may be used based on that information. Upon that level of belief meeting or exceeding a particular threshold, computing device 100 may propose adjusting current aircraft ground movement routes to the routes that cross that runway.

As an additional example, the set of states may include routes that include different directions (e.g., left and right) from which currently landing aircraft can exit the runway. Upon receiving information about (e.g., observations of) the occupancy status of the exit branches of the runway (e.g., whether the branches are fee or occupied), the hidden Markov model can calculate a level of belief (e.g., probability) that a currently landing aircraft can exit the runway in a particular direction based on that information. Upon that level of belief meeting or exceeding a particular threshold, computing device 100 may propose adjusting current aircraft ground movement routes for currently landing aircraft to exit the runway in that direction.

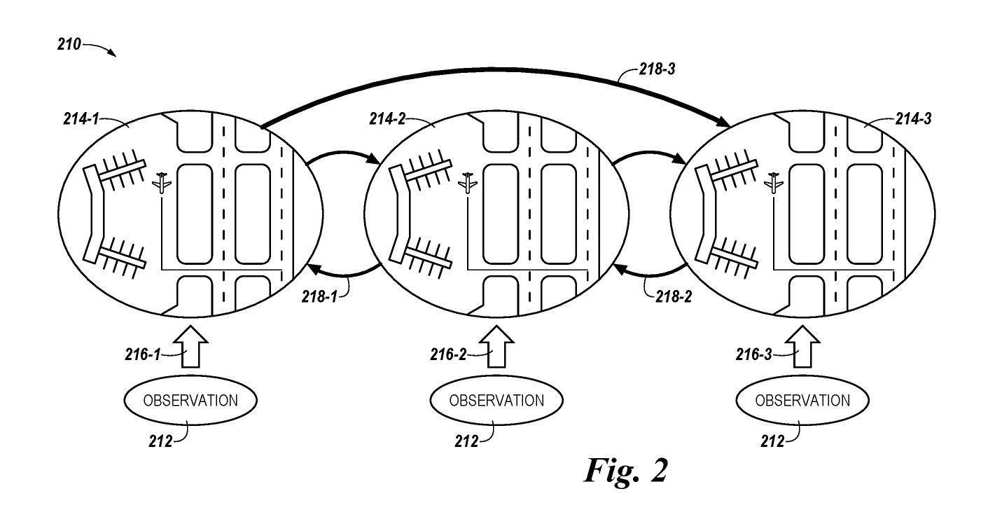

The hidden Markov model can include (e.g., be composed of) state transition probabilities and observation probabilities that it can use to determine the possible adjustment to the current aircraft ground movement route. The state transition probabilities can define how often each of the different aircraft ground movement routes in the set of states is being used as the current aircraft ground movement route at the airport. The observation probabilities can define the probability that each of the different aircraft ground movement routes in the set of states is being used as the current aircraft ground movement route at the airport based on the received information associated with the current aircraft ground movements at the airport. An example of a hidden Markov model will be further described herein (e.g., in connection with FIG. 2).

As such, computing device 100 can determine when a change in the state of the current aircraft ground movements at the airport has occurred based, at least in part, on the received information associated with the current aircraft ground movements at the airport, and propose an adjustment to the current aircraft ground movement route upon determining such a change has occurred. Further, computing device 100 can include in the proposed adjustment the probability that the proposed adjustment will work. For instance, the proposed adjustment may include the probability that the proposed adjustment will make the current aircraft ground movement quicker and/or the probability that the proposed adjustment will be safe.

After computing device 100 proposes the adjustment to the current aircraft ground movement route at the airport, the user (e.g., air traffic controller) of computing device 100 may decide whether to accept the proposed adjustment. If the user decides to accept the proposed adjustment, the user can enter the acceptance via user interface 106. For instance, the user can make an entry or selection via user interface 106 that indicates the user's acceptance of the proposed adjustment.

Upon receiving the acceptance of the proposed route adjustment, computing device 100 can make the proposed adjustment to the current aircraft ground movement route. That is, computing device 100 can adjust the current aircraft ground movement route according to the proposed adjustment upon receiving the acceptance of the proposed adjustment. The ASMGCS of the airport can be updated to reflect the acceptance of the proposed adjustment, and user interface 106 can provide confirmation to the user that the proposed adjustment has been accepted. For example, user interface 106 can update the display of the map of the airport runway to include the adjusted route.

FIG. 2 illustrates an example structure of a hidden Markov model 210 in accordance with one or more embodiments of the present disclosure. The hidden Markov model 210 can be used to determine possible adjustments to the current aircraft ground movement route in accordance with the present disclosure.

As shown in FIG. 2, hidden Markov model 210 can include a set of states 214-1, 214-2, 214-3. Each respective state 214-1, 214-2, 214-3 can correspond to a different (e.g., preferred) aircraft ground movement route for different aircraft ground movement conditions and/or situations. Although three states are shown in the example illustrated in FIG. 2, embodiments of the present disclosure are not limited to a particular number of states. The set of states (e.g., each of the different routes of the set) can correspond to a set of aircraft ground movement routing rules, as previously described herein (e.g., in connection with FIG. 1).

As shown in FIG. 2, information associated with the current aircraft ground movements can be input into hidden Markov model 210 in the form of observations 212. This information can include, for example, observations and/or measurements of the current aircraft ground movements, as previously described herein (e.g., in connection with FIG. 1).

As shown in FIG. 2, hidden Markov model 210 can include observation probabilities in the form of observation probability matrices 216-1, 216-2, 216-3. Each respective observation probability matrix 216-1, 216-2, 216-3 can define the probability that each of the different aircraft ground movement routes in the set of states 214-1, 214-2, 214-3 is being used as the current aircraft ground movement route at the airport based on observations 212. For instance, observation probability matrix 216-1 can define the probability that the aircraft ground movement route of state 214-1 is being used as the current aircraft ground movement route at the airport based on observations 212, observation probability matrix 216-2 can define the probability that the aircraft ground movement route of state 214-2 is being used as the current aircraft ground movement route at the airport based on observations 212, etc.

As shown in FIG. 2, hidden Markov model 210 can also include state transition probabilities in the form of state transition probability matrices 218-1, 218-2, 218-3. Each respective state transition probability matrix 218-1, 218-2, 218-3 can define how often each of the different aircraft ground movement routes in the set of states 214-1, 214-2, 214-3 is being used as the current aircraft ground movement route at the airport. For instance, state transition probability matrix 218-1 can define how often the aircraft ground movement route of state 214-1 is being used as the current aircraft ground movement route at the airport, state transition probability matrix 218-1 can define how often the aircraft ground movement route of state 214-1 is being used as the current aircraft ground movement route at the airport, etc.

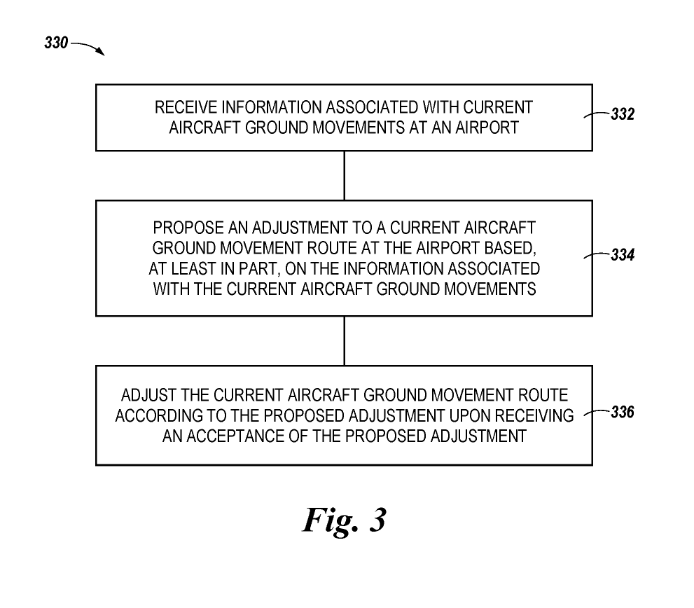

FIG. 3 illustrates a method 330 for routing aircraft ground movements at an airport in accordance with one or more embodiments of the present disclosure. Method 330 can be performed by, for example, computing device 100 previously described in connection with FIG. 1.

At block 332, method 330 includes receiving information associated with current aircraft ground movements at an airport. This information can include, for example, observations and/or measurements of current aircraft ground movements, as previously described herein (e.g., in connection with FIG. 1).

At block 334, method 330 includes proposing an adjustment to a current aircraft ground movement route based, at least in part, on the information associated with the current aircraft ground movements. Proposing the adjustment can include, for example, determining a possible adjustment to the current aircraft ground movement route based, at least in part, on the information associated with the current aircraft ground movements, and providing the possible adjustment to a user of the computing device (e.g., an air traffic controller), as previously described herein (e.g., in connection with FIG. 1). In some embodiments, the adjustment can be determined using a hidden Markov model, as previously described herein.

At block 336, method 330 includes adjusting the current ground movement route according to the proposed adjustment upon receiving an acceptance of the proposed adjustment. The acceptance of the proposed adjustment may be received, for example, from the user of the computing device, as previously described herein (e.g., in connection with FIG. 1).

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for routing aircraft ground movements at an airport, comprising:
a memory;
a processor configured to execute executable instructions stored in the memory to:
receive information associated with current aircraft ground movements at an airport; and
determine a possible adjustment to a current aircraft ground movement route at the airport based, at least in part, on the information associated with the current aircraft ground movements; and
a user interface configured to provide the possible adjustment to the current aircraft ground movement route to a user of the computing device.

2. The computing device of claim 1, wherein the processor is configured to execute the instructions to determine the adjustment to the current aircraft ground movement route using a hidden Markov model.

3. The computing device of claim 1, wherein:
the user interface is configured to receive an acceptance of the adjustment to the current aircraft ground movement route from the user; and
the processor is configured to execute the instructions to make the adjustment to the current aircraft ground movement route upon the user interface receiving the acceptance of the adjustment.

4. The computing device of claim 1, wherein the processor is configured to execute the instructions to determine the possible adjustment to the current aircraft ground movement route by applying a set of aircraft ground movement routing rules to the information associated with the current aircraft ground movements.

5. The computing device of claim 4, wherein the computing device is configured to execute the instructions to determine the set of aircraft ground movement routing rules based, at least in part, on:
information associated with previous aircraft ground movements at the airport; and
previous aircraft ground movement routes at the airport.

6. The computing device of claim 4, wherein the computing device is configured to execute the instructions to determine the set of aircraft ground movement routing rules based, at least in part, on information received from the user of the computing device.

7. The computing device of claim 4, wherein the set of aircraft ground movement routing rules corresponds to a set of states of a hidden Markov model.

8. The computing device of claim 1, wherein the computing device is a computing device of an advanced surface movement guidance and control system of the airport.

9. A method for routing aircraft ground movements at an airport, comprising:
receiving, by a computing device, information associated with current aircraft ground movements at an airport;
proposing, by the computing device, an adjustment to a current aircraft ground movement route at the airport based, at least in part, on the information associated with the current aircraft ground movements; and
adjusting, by the computing device upon receiving an acceptance of the proposed adjustment to the current aircraft ground movement route, the current aircraft ground movement route according to the proposed adjustment.

10. The method of claim 9, wherein the current aircraft ground movement route includes:
a route of an aircraft from a gate of the airport to a runway of the airport; or
a route of an aircraft from a runway of the airport to a gate of the airport.

11. The method of claim 9, wherein the method includes:
determining, by the computing device, when a change in a state of the current aircraft ground movements at the airport occurs based, at least in part, on the information associated with the current aircraft ground movements; and
proposing, by the computing device, the adjustment to the current aircraft ground movement route at the airport upon determining a change in the state of the current aircraft ground movements at the airport has occurred.

12. The method of claim 9, wherein the proposed adjustment to the current aircraft ground movement route includes a probability that the proposed adjustment will make the current aircraft ground movement route quicker.

13. The method of claim 9, wherein proposing the adjustment to the current aircraft ground movement route includes:
determining, by the computing device, a possible adjustment to the current aircraft ground movement route; and
displaying, by the computing device, the possible adjustment to the current aircraft ground movement route.

14. A non-transitory computer readable medium having computer readable instructions stored thereon that are executable by a processor to:
receive information associated with current aircraft ground movements at an airport;
input the information associated with the current aircraft ground movements into a hidden Markov model; and
determine, using the hidden Markov model, a possible adjustment to a current aircraft ground movement route at the airport.

15. The computer readable medium of claim 14, wherein:
the hidden Markov model includes a set of states, wherein each respective state of the set corresponds to a different aircraft ground movement route at the airport; and
the possible adjustment to the current aircraft ground movement route includes an adjustment of the current aircraft ground movement route to one of the different aircraft ground movement routes in the set of states.

16. The computer readable medium of claim 15, wherein:
the instructions are executable by the processor to determine, using the hidden Markov model, levels of belief in each respective state of the set; and
the possible adjustment to the current aircraft ground movement route includes an adjustment to one of the different aircraft ground movement routes in the set of states if the level of belief in the state of the set corresponding to that respective aircraft ground movement route meets or exceeds a particular threshold.

17. The computer readable medium of claim 15, wherein the hidden Markov model includes:
state transition probabilities that define how often each of the different aircraft ground movement routes in the set of states is the current aircraft ground movement route at the airport; and
observation probabilities that define a probability that each of the different aircraft ground movement routes in the set of states is the current aircraft ground movement route at the airport based on the information associated with the current aircraft ground movements at the airport.

18. The computer readable medium of claim 14, wherein the information associated with the current aircraft ground movements includes a change in congestion in the current aircraft ground movements at the airport.

19. The computer readable medium of claim 14, wherein the information associated with the current aircraft ground movements includes a current number of landings on a runway of the airport.

20. The computer readable medium of claim 14, wherein the information associated with the current aircraft ground movements includes an occupancy status of a runway branch of the airport.
